(19) United States
(12) Patent Application Publication
(10) Pub. No.: US 2006/0050471 A1
(43) Pub. Date: Mar. 9, 2006

(54) Monitor frame structure

(76) Inventor: Yin-Hung Chen, Taipei (TW)

Correspondence Address: Yi-Wen Tseng, 4331 Stevens Battle Lane, Fairfax, VA, 22033, US

(21) Appl. No.: 10/934,584

(22) Filed: Sep. 3, 2004

(51) Int. Cl. G06F 1/16

(52) U.S. Cl. 361/681

(57) ABSTRACT

A liquid crystal display (LCD) monitor frame structure, which completely surrounds a LCD monitor's perimeter and thereby provides the LCD monitor with a protective structure. The LCD frame structure provided by the present invention includes a display and a fixing frame. The display includes a display unit and a body cover which completely surrounds the perimeter of the display unit. The body cover is assembled by combining a primary case shell with a secondary case shell. The fixing frame of the LCD monitor frame structure which encloses the display of the monitor greatly reduces the number of elements required to assemble the LCD monitor frame. The present invention is light weight and easy to assemble. It further provides the LCD monitor with a protective structure which is capable of preventing the body cover of the monitor from being cracked by an accidental impact.

### BACKGROUND OF THE INVENTION

The present invention relates in general to a monitor frame structure, and more particularly, to a liquid crystal display (LCD) monitor frame structure, which completely surrounds a LCD monitor's perimeter and thereby provides the LCD monitor with a protective structure.

The LCD monitor has recently replaced the conventional CRT monitor because of its light weight and small volume. In addition, the image quality of a LCD monitor is far better than that of a CRT monitor. The LCD monitor has become a well accepted product among most consumers. When choosing a LCD monitor, consumers often consider the LCD monitor's light weight, price, and structural strength. For this reason, the issue of a simple and high strength LCD monitor structure needs to be addressed.

The Taiwan utility model patent number 572554 discloses a conventional LCD monitor frame structure. It includes a fixing frame which surrounds the perimeter of a LCD monitor. The fixing frame is formed by combining a front frame, a middle frame, and a rear frame. The body of these frames is made up of two opposing lateral frame plates and two opposing longitudinal frame plates which are assembled together. A rectangular flange strip is formed inside the front frame. A rectangular insert ear is correspondingly formed inside the middle frame. The middle frame further has a rectangular screw ear formed on its side opposing the rear frame. The front, middle, and rear frames can be securely assembled together by insertion, screwing and other methods. The fixing frame is thereby assembled onto the LCD monitor.

However, the conventional LCD frame is made up of a several frame plates. It is because the conventional LCD frame is made up of several frame plates that unreasonable material and manufacturing wastes are created. Even aside from both the material and manufacturing wastes, the assembly procedure for a conventional LCD frame is tedious and troublesome which results in the added waste of time. Further, the LCD monitor when assembled with the conventional frame is so heavy that transportation and adjustment of the monitor become inconvenient. Additionally, the conventional frame structure has a large volume which takes up the consumer's valuable and limited work space. Because of these aforementioned problems, the use of the conventional LCD frame decreases a monitor's utility and economic efficiency.

### BRIEF SUMMARY OF THE INVENTION

The present invention provides a LCD frame structure which completely surrounds a LCD monitor's perimeter and provides the LCD monitor with a protective structure. The fixing frame of the LCD monitor frame structure which encloses the display of the monitor greatly reduces the number of elements required to assemble the LCD monitor frame. The present invention is light weight and easy to assemble. It further provides the LCD monitor with a protective structure which is capable of preventing the body cover of the monitor from being cracked by an accidental impact.

The LCD frame structure provided by the present invention includes a display and a fixing frame. The display includes a display unit and a body cover which completely surrounds the perimeter of the display unit. The body cover is assembled by combining a primary case shell with a secondary case shell. A conjunction portion is formed around the outer circumference of the body cover in order to facilitate its combining with the fixing frame. Additionally, a receptive space which is enclosed by the fixing frame body is utilized in order to install the display.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These as well as other features of the present invention will become more apparent upon reference to the drawings therein:

FIG. 1 is an exploded view of a LCD monitor which utilizes the frame structure of the present invention.

FIG. 2 is a perspective view of a LCD monitor around which the frame structure of the present invention is installed.

FIG. 3 is a rear perspective view of a LCD monitor with the frame structure of the present invention installed.

FIG. 4 is a side view of a LCD monitor with the frame structure of the present invention installed.

FIG. 5 is a perspective view of a LCD monitor around which the frame structure of the second embodiment of the present invention is installed.

FIG. 6 is a perspective view of a LCD monitor around which the frame structure of the third embodiment of the present invention is installed.

FIG. 7 is a perspective view of a LCD monitor around which the frame structure of the fourth embodiment of the present invention is installed.

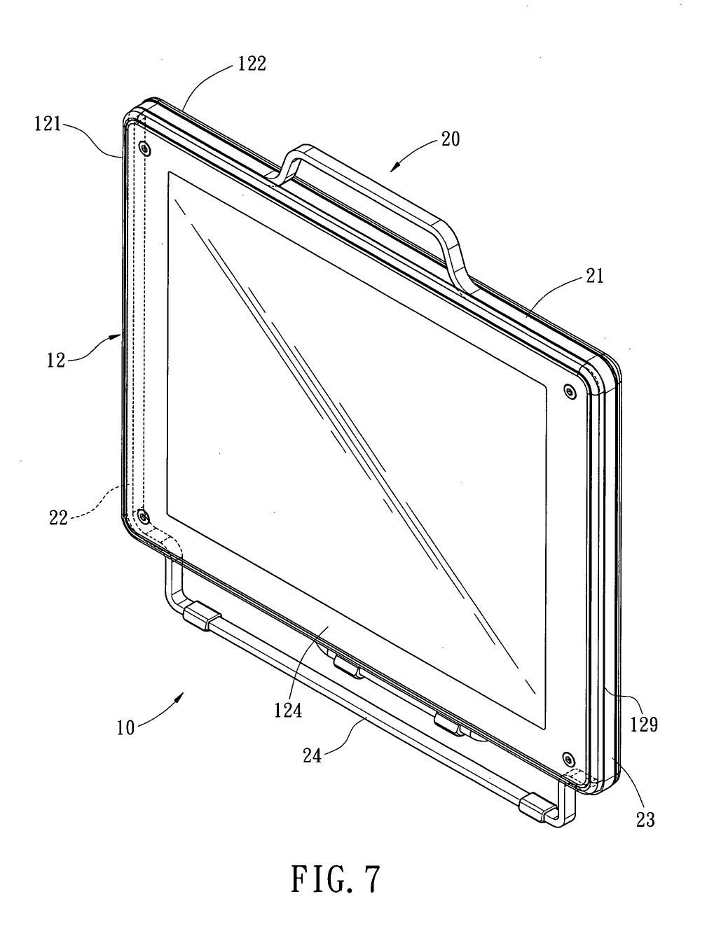

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the descriptions to refer to the same or like parts.

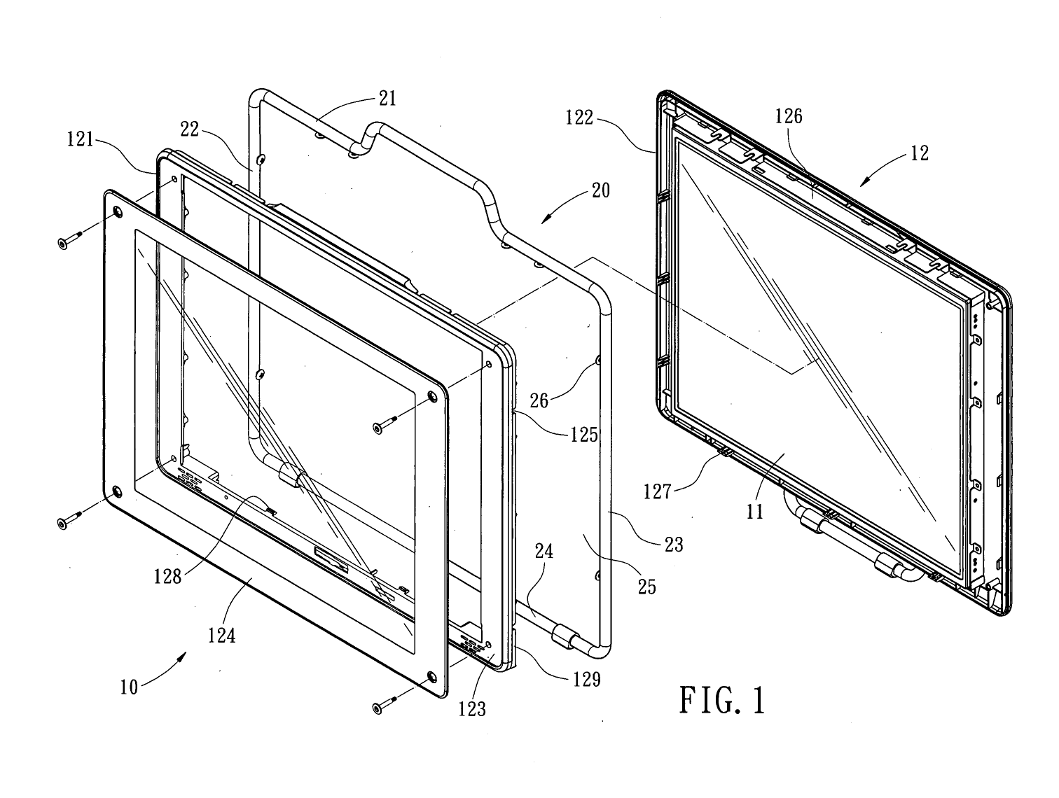

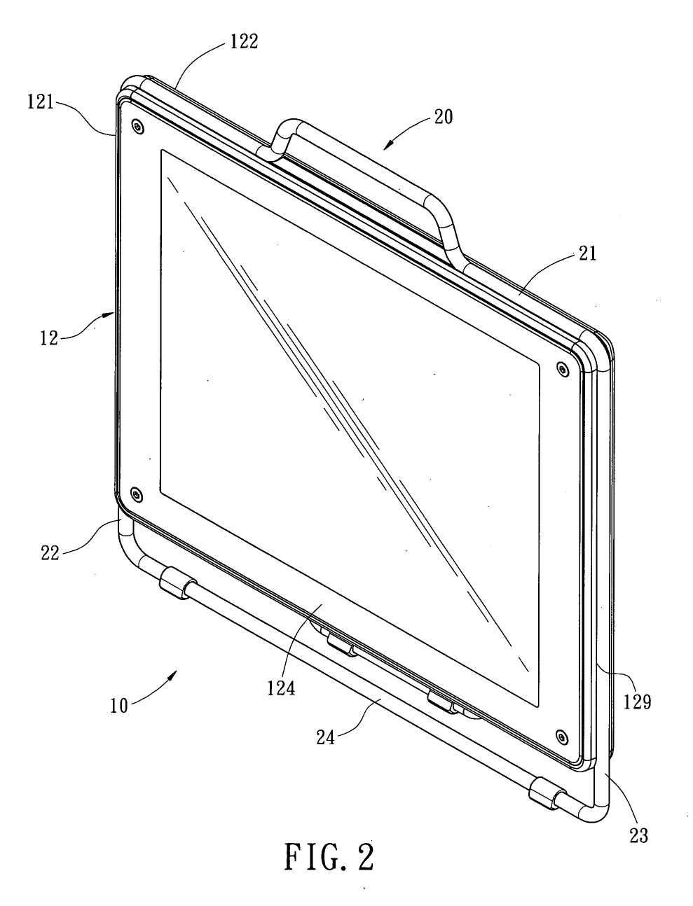

Referring to FIGS. 1 and 2, the present invention provides a LCD monitor frame structure which includes a display 10 and a fixing frame 20.

The display 10 includes a display unit 11 and a body cover 12 which completely encapsulates the perimeter of the display unit 11. The body cover 12 which is made from plastic material is assembled by combining a primary case shell 121 with a secondary case shell 122. The primary case shell 121 is hollow and rectangular in shape. A rectangular insulating layer 123 is formed on the front side of the primary case shell 121 in order to provide the display unit 11 with a protective laminar. The primary case shell 121, further, has a plurality of slot holes 125 formed around its top and both of its sides. The secondary case shell 122 has a plurality of fixing tabs 126. The space enclosed by the fixing tabs 126 is utilized to install the display unit 11. The fixing tabs 126 have a plurality of fastener buttons 127 which are formed at their outer edges and correspond to the primary case shell's 121 plurality of fastener connectors 128. These fastener buttons and fastener connectors are utilized in order to securely attach the primary case shell 121 to the secondary case shell 122. In addition, a conjunctive portion 129 is formed around the outer circumference of the body cover 12. The conjunction portion 129 of the present invention is a concave groove.

The fixing frame 20 may be constructed from tubular, beam or plate material. The cross sectional shape of the frame body 20 may be a circle, a rectangle, or other geometric configuration. The present invention is constructed from tubular material.

The fixing frame 20 is utilized in order to install the display 10. The left beam 22 and the right beam 23 are connected to the conjunction portions 129 of the body cover 12, while the top beam 21 is utilized to form a convenient carrying handle. In addition, a space is retained between the bottom beam 24 and the bottom of the display 10 to improve shock absorption.

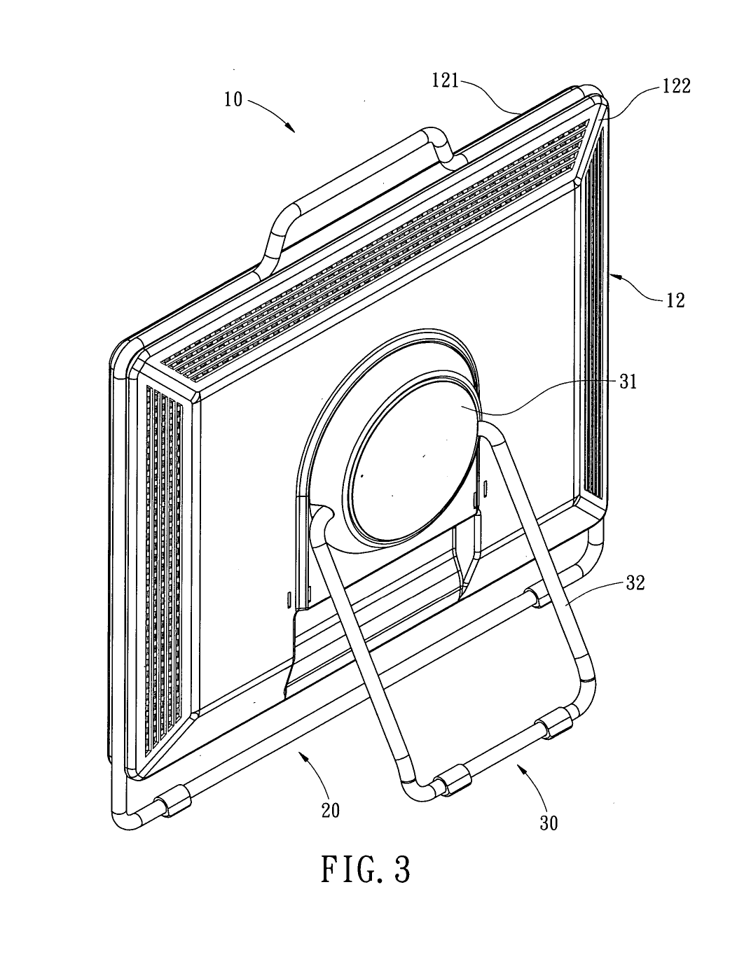

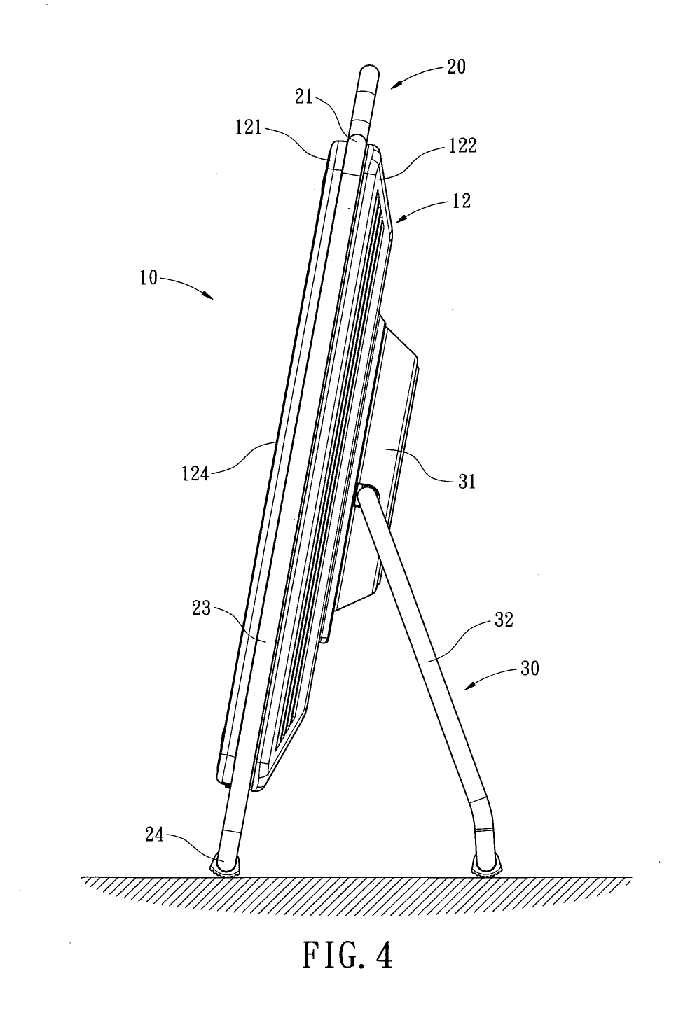

Referring to FIGS. 3 and 4, a rear perspective view and a side view of the first embodiment of the present invention are show respectively. A supporting member 30 may be installed onto the rear of the secondary case shell 122. The supporting member 30 includes a rotatable disk 31 which is pivoted in order to create a stable structure for erection of the display 10. To utilize the monitor, force is applied to unfold the supporting stand 32. Such an unfolding force is sufficient to rotate the bottom edge of the supporting stand 32 outward. Once rotated outward, a distance will have been created between the bottom of the fixing frame 20 and the bottom edge of the supporting stand 32. It is this distance that allows the fixing frame 20 to be propped up by the supporting member 30. This propping of the fixing frame 20 erects the display 10 on any table or other planar surface and provides the desired angle for viewing the display 10. Even if the display 10 is not equipped with the supporting member 30, the display 10 can be hung on a wall by utilizing the handle portion of the top beam 21 of the fixing frame 20.

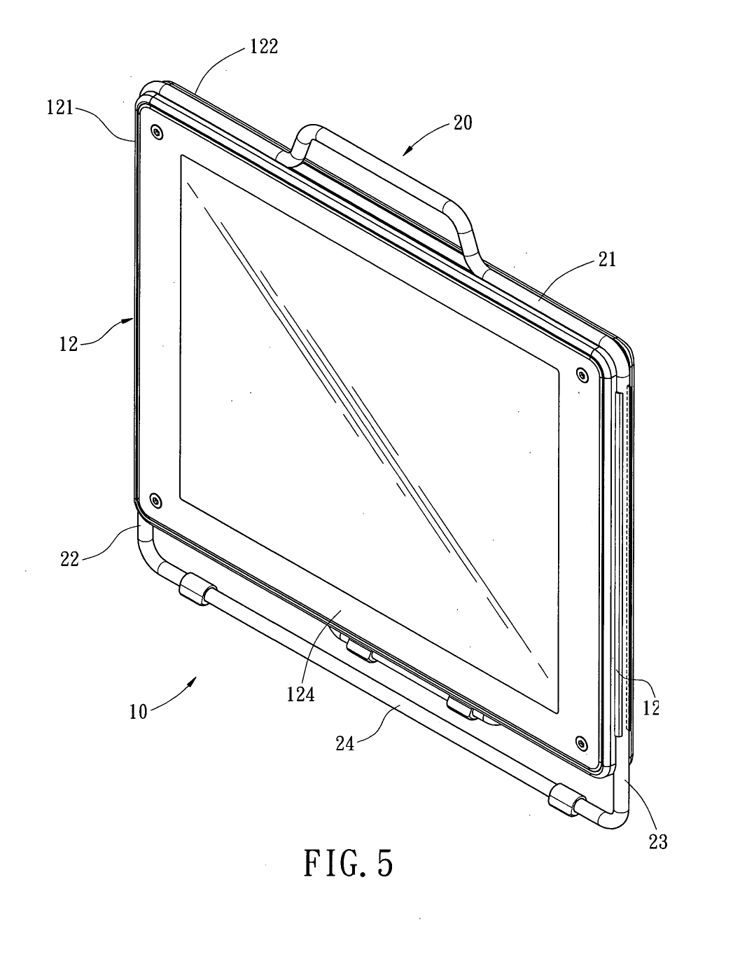

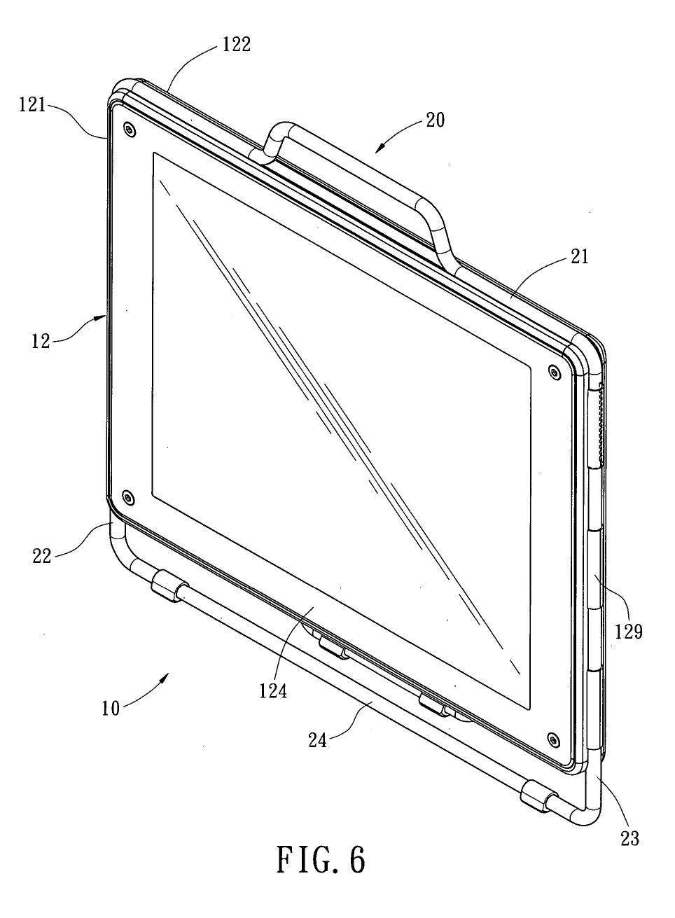

Referring to FIGS. 5 and 6, the second and third embodiments of the present invention, when fully assembled, are shown respectively. The conjunction portion 129 of the fixing frame 20 may be formed by a continuous or a discontinuous flange portion extending from the outer sides of the body cover 12. The configuration of the flange portion 129 may be either two arcs as illustrated in FIG. 5, or a semi-circle as illustrated in FIG. 6. By utilizing the flange portion, the body cover 12 is securely fixed to the fixing frame 12.

A LCD monitor frame structure in accordance with the present invention is beneficial in at least three ways. First, the installation of the fixing frame greatly reduces the number of composition elements required for the LCD monitor frame. The present invention is light weight and easy to assemble. It further provides the body cover of the monitor with a protective structure which is capable of preventing the body cover from becoming cracked by an accidental impact. Second, the installation of the handle facilitates the easy carrying of a monitor. The handle can also be utilized to hang a monitor onto a wall. A monitor is thereby capable of more fully satisfying the needs of its owner since it can be adapted for use in various environments. Third, by utilizing the support of the fixing frame and the supporting member, the monitor can be stably erected with a satisfactory slope on any table or other planar surface.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. A monitor frame structure, comprising:
a display including a display unit and a body cover which completely surrounds the perimeter of the display unit, and wherein the body cover is assembled by combining a primary case shell, a conjunction portion being formed around the perimeter thereof; and
a fixing frame having a receptive space formed therewithin to facilitate the installation of the display, the fixing frame being securely installed onto the conjunction portion of the body cover.

2. The monitor frame structure of claim 1, wherein a rectangular insulating layer is formed on the front side of the primary case shell in order to install a protective plate.

3. The monitor frame structure of claim 1, wherein the conjunction portion is a concave groove, the outer diameter of the fixing frame is sized in accordance with the inner diameter of the concave groove.

4. The monitor frame structure of claim 1, wherein the conjunction portion is a flange portion which may be either two arcs or a semi-circle in shape.

5. The monitor frame structure of claim 1, wherein the secondary case shell has a plurality of fastener buttons which correspond to the primary case shell's plurality of fastener connectors, these fastener buttons and fastener connectors being utilized in order to securely fix the primary case shell to the secondary case shell.

6. The monitor frame structure of claim 1, wherein the fixing frame is made from tubular, beam, or plate material.

7. The monitor frame structure of claim 1, wherein the cross section of the fixing frame is either circular or rectangular.

8. The monitor frame structure of claim 1, wherein the fixing frame is formed by enclosing a top beam, a left beam, a right beam, and a bottom beam, a handle portion being formed on the top beam, a space being preserved between the bottom beam and the bottom of the display.
